(19) United States
(12) Patent Application Publication
(10) Pub. No.: US 2010/0131858 A1
(43) Pub. Date: May 27, 2010

(54) USER INTERFACE

(75) Inventors: Paul T. Schultz, Colorado Springs, CO (US); Robert A. Sartini, Colorado Springs, CO (US); Martin W. McKee, Herndon, VA (US)

Correspondence Address: VERIZON;PATENT MANAGEMENT GROUP, 1320 North Court House Road, 9th Floor, ARLINGTON, VA, 22201-2909, US

(73) Assignee: VERIZON BUSINESS NETWORK SERVICES INC., Ashburn, VA (US)

(21) Appl. No.: 12/275,319

(22) Filed: Nov. 21, 2008

(51) Int. Cl. G06F 3/00; G06F 17/30; G06F 12/00

(52) U.S. Cl. 715/751; 707/E17.044; 709/227

(57) ABSTRACT

A device may include a user interface configured to provide audio, video or haptic output in response to received communications. The device may also include logic to identify information associated with an availability status of a user of the device and provide an audio, video or haptic output via the user interface based on the information associated with the availability status of the user of the device.

### BACKGROUND INFORMATION

Common devices, such as mobile phones, personal digital assistants (PDAs), television remote controls and game controllers, have become increasingly complex. As a result, human/machine interfaces that allow users to interact with these devices have also become more complex. The complexity of the human/machine interface often leads to problems, such as user frustration and errors with respect to performing various functions, as well as not being able to utilize these devices to their fullest capabilities.

### BRIEF DESCRIPTION OF THE DRAWINGS

FIG. 1 illustrates an exemplary network in which systems and methods described herein may be implemented;

FIG. 2 is a diagram of an exemplary user device of FIG. 1;

FIG. 3 is a functional diagram of components implemented in the device of FIG. 2;

FIG. 4 is a functional diagram illustrating exemplary logic components implemented in a user device of FIG. 1;

FIG. 5 is a flow diagram illustrating exemplary processing associated with managing the user interface of a user device of FIG. 1;

FIG. 6 is a diagram of an exemplary processing tree implemented by logic components illustrated in FIG. 4;

FIG. 7 is a table illustrating variations associated with providing audio, video and haptic input/output mechanisms via a user interface;

FIG. 8 is a diagram of exemplary functional components implemented in a user device of FIG. 1;

FIG. 9 is a flow diagram illustrating exemplary processing associated with managing a communication session; and

FIGS. 10A and 10B illustrate exemplary displays provided by a user device during a communication session.

### DETAILED DESCRIPTION OF PREFERRED EMBODIMENTS

The following detailed description refers to the accompanying drawings. The same reference numbers in different drawings may identify the same or similar elements. Also, the following detailed description does not limit the embodiments disclosed herein.

Implementations described herein relate to a device that includes a user interface that leverages audio, visual and/or haptic/touch input and/or output mechanisms to provide a rich, user-friendly interface. In some implementations, the user interface automatically provides one or more of audio, video and/or haptic output and allows the user to provide one or more inputs based on various factors, such as the particular operating conditions or scenarios in which the device is currently operating. In other implementations, logic associated with managing one or more messaging programs provides a simplified interface for performing various functions to enhance the user's experience with respect to communicating with other devices.

In some instances, possible outputs and inputs of the user interface are organized in groups of N (e.g., three) and M (e.g., three), respectively. To provide outputs (e.g., show information on a display screen) in connection with a device event (e.g., the reception of an incoming call), the user interface may provide one or more outputs in the group that is associated with and appropriate for that event. Similarly, to accept inputs for a particular device action (e.g., make a call or send a response), the user interface may enable one or more inputs in the group associated with and appropriate for the action. By providing outputs and/or accepting inputs that are in groups of N and M, respectively, the user interface may reduce user cognitive load and simplify use of the device.

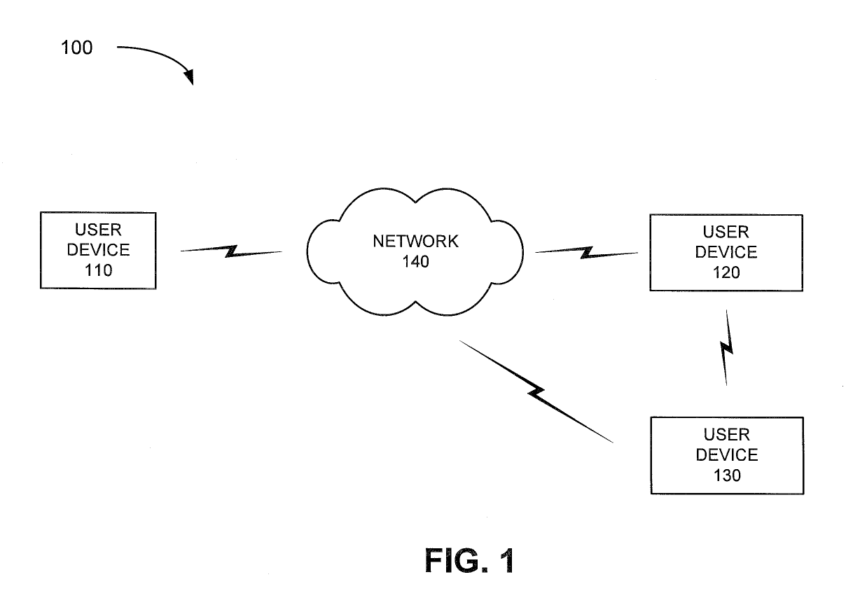

FIG. 1 is a block diagram of an exemplary network 100 in which systems and methods described herein may be implemented. Network 100 may include user device 110, user device 120, user device 130 and network 140. User devices 110-130 may connect to network 140 and/or each other via wired, wireless or optical communication mechanisms.

Each of user devices 110-130 may include a cellular radiotelephone, personal digital assistant (PDA), pager, or similar communications device with data communications and/or data processing capabilities. For example, user devices 110-130 may each include a cellular telephone, PDA, web-based appliance or pager that includes a Web browser or other application providing Internet/Intranet access, messaging application programs, such as text messaging, multi-media messaging, instant messaging, e-mail, etc., an organizer application program, a calendar application program, video application and/or a global positioning system (GPS) receiver. In an alternative implementation, one or more of user devices 110-130 may include a personal computer (PC), laptop computer, palmtop receiver, remote control device and/or any other appliance that may include a radiotelephone transceiver and other applications for providing data processing and data communication functionality.

In another implementation, one or more of user devices 110-130 may include a remote control device that is able to remotely control a television, a stereo, a video cassette recorder (VCR), a digital video disc (DVD) player, a compact disc (CD) player, a video game system, etc. In still another implementation, one or more of user devices 110-130 may include various user equipment, such as a video game system, a television, a VCR, a DVD player, a CD player, etc., that may be controlled by or interact with other ones of user devices 110-130.

Network 140 may include one or more wired, wireless and/or optical networks that are capable of receiving and transmitting data, voice and/or video signals, including multimedia signals that include voice, data and video information. For example, network 140 may include one or more public switched telephone networks (PSTNs) or other type of switched network. Network 140 may also include one or more wireless networks and may include a number of transmission towers for receiving wireless signals and forwarding the wireless signals toward the intended destination. Network 140 may further include one or more packet switched networks, such as an Internet protocol (IP) based network, a local area network (LAN), a wide area network (WAN), a personal area network (PAN), an intranet, the Internet, or another type of network that is capable of transmitting data.

The exemplary configuration illustrated in FIG. 1 is provided for simplicity. It should be understood that a typical network may include more or fewer devices than illustrated in FIG. 1. For example, other devices that facilitate communications between the various entities illustrated in FIG. 1 may also be included in network 100. In addition, user devices 110-130 are each shown as separate elements. In other instances, the functions described as being performed by two or more user devices may be performed by a single user device. For example, in some instances, user device 110 may be a game controller and user device 130 may be a game console, while in other instances, these devices may be integrally formed as a single user device. In other implementations, the functions described as being performed by one user device may be performed by another user device or by multiple user devices.

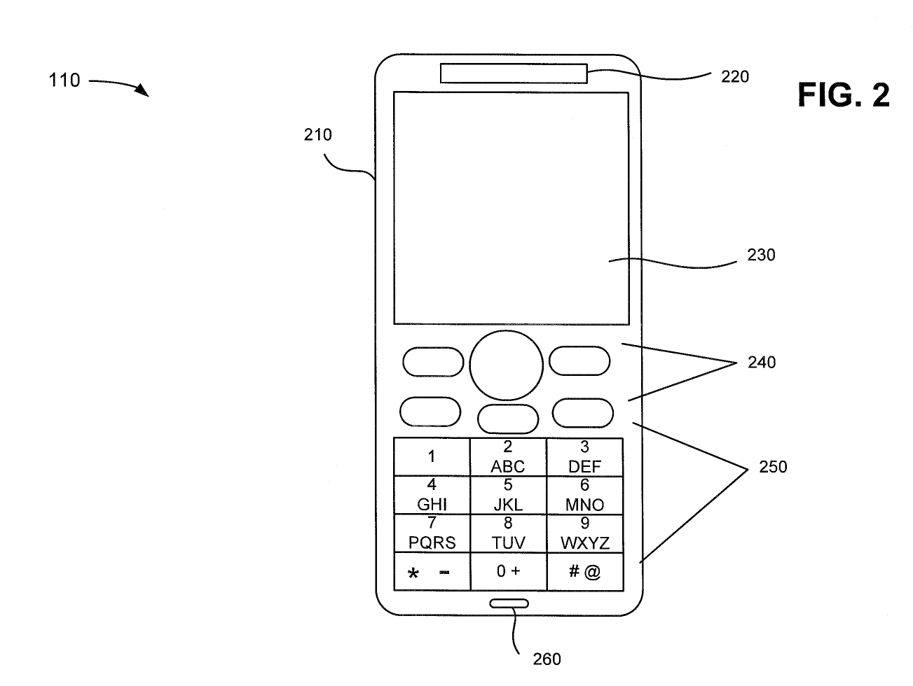

FIG. 2 is a diagram of an exemplary user device 110 in which methods and systems described herein may be implemented. Referring to FIG. 2, user device 110 may include housing 210, speaker 220, display 230, control buttons 240, keypad 250, and microphone 260. Housing 210 may protect the components of user device 110 from outside elements. Speaker 220 may provide audible information to a user of user device 110. For example, speaker 220 may provide ringtones, beeping sounds or other sounds to alert the user to an event. Speaker 220 may also output audio information or instructions to a user of user device 110.

Display 230 may provide visual information to the user. For example, display 230 may include a liquid crystal display (LCD), a touch screen display or another type of display used to provide information to a user, such as provide information regarding incoming or outgoing telephone calls and/or incoming or outgoing electronic mail (email), instant messages (e.g., mobile instant messages (MIMs), short message service (SMS) messages, multi-media message service (MMS) messages, etc. Display 230 may also display information regarding various applications, such as a calendar application or text message application stored in user device 110, the current time, video games being played by a user, downloaded content (e.g., news or other information), etc.

Control buttons 240 may permit the user to interact with user device 110 to cause user device 110 to perform one or more operations, such as send communications (e.g., text messages or multi-media messages), place a telephone call, play various media, etc. For example, control buttons 240 may include a send button, an answer button, a dial button, a hang up button, a clear button, a play button, etc. In an exemplary implementation, control buttons 240 may also include one or more buttons that may be used to launch an application program, such as a messaging program. Further, one of control buttons 240 may be a menu button that permits the user to view options associated with executing various application programs, such as messaging programs, stored in user device 110. Control buttons 240 may perform different operations depending on the user's context and the application that the user is currently utilizing.

Keypad 250 may include a telephone keypad. As illustrated, many of the keys on keypad 250 may include numeric values and various letters. For example, the key with the number 2 includes the letters A, B and C. These letters may be selected by a user when inputting text to user device 110. Other keys on keypad 250 may include symbols, such as the plus symbol (i.e., +), the minus symbol (i.e., −), the at symbol (i.e., @), etc. These symbols may be used to perform various functions, as described in detail below. Microphone 260 may receive audible information from the user. User device 110 may also include haptic capabilities for communicating with the user via tactile feedback.

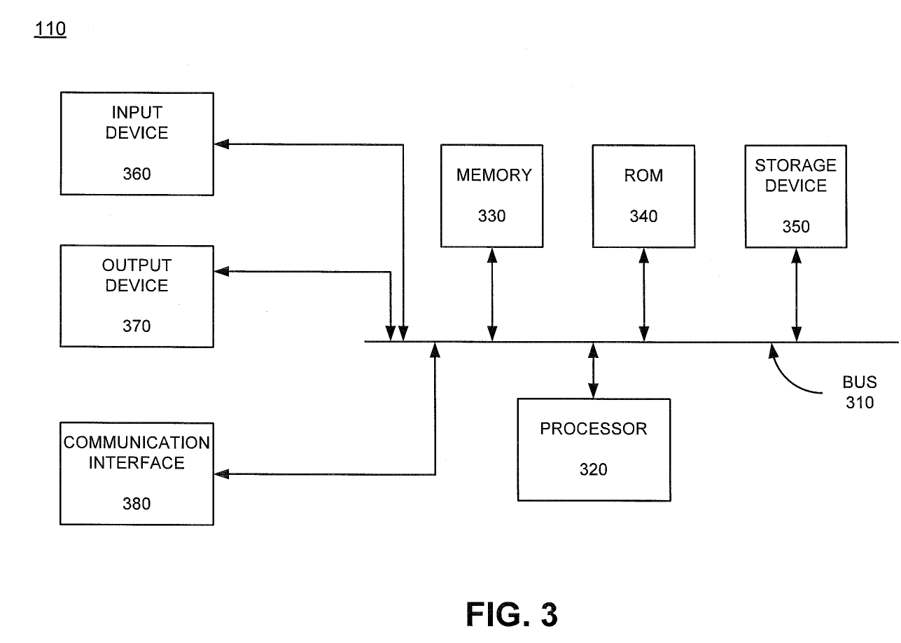

FIG. 3 is a diagram illustrating components of user device 10 according to an exemplary implementation. In some implementations, user devices 120 and 130 may be configured in a similar manner. Referring to FIG. 3, user device 110 may include bus 310, processor 320, main memory 330, read only memory (ROM) 340, storage device 350, input device 360, output device 370, and communication interface 380. Bus 310 may include a path that permits communication among the elements of user device 110. It should be understood that user device 110 may be configured in a number of other ways and may include other or different elements. For example, user device 110 may include one or more power supplies and one or more modulators, demodulators, encoders, decoders, etc., for processing data.

Processor 320 may include one or more processors, microprocessors, application specific integrated circuits (ASICs), field programmable gate arrays (FPGAs), or other processing logic that may interpret and execute instructions. Memory 330 may include a random access memory (RAM) or another type of dynamic storage device that may store information and instructions for execution by processor 320. ROM 340 may include a ROM device or another type of static storage device that may store static information and instructions for use by processor 320. Storage device 350 may include a magnetic and/or optical recording medium and its corresponding drive.

Input device 360 may include one or more mechanisms that permit a user to input information to user device 10, such as a control keys 240, keypad 250, microphone 260, a touch screen, such as display 230, a mouse, a pen, voice recognition and/or biometric mechanisms, etc.

Output device 370 may include one or more mechanisms that output information to the user, including a display, such as display 230, a printer, one or more speakers, such as speaker 220, a vibrating mechanism that provides haptic feedback to a user, etc.

Communication interface 380 may include any transceiver-like mechanism that enables user device 110 to communicate with other devices and/or systems. For example, communication interface 380 may include mechanisms for communicating via a network, such as a wireless network. In these implementations, communication interface 380 may include one or more radio frequency (RF) transmitters, receivers and/or transceivers and one or more antennas for transmitting and receiving RF data via network 140. Communication interface 380 may also include an infrared (IR) transmitter and receiver and/or transceiver that enable user device 110 to communicate with other devices via infrared (IR) signals. For example, in one implementation, user device 110 may act as a remote control device and use IR signals to control operation of another device, such as a television, stereo, etc. Communication interface 380 may also include a modem or an Ethernet interface to a LAN or other network for communicating with other devices in network 100. Alternatively, communication interface 380 may include other mechanisms for communicating via a network, such as network 140.

User device 110 may provide a platform for a user to make and receive telephone calls, initiate and receive video sessions, send and receive electronic mail, text messages, IMs, MMS messages, SMS messages, etc., and execute various other applications. User device 110, as described in detail below, may also perform processing associated with managing the user interface of user device 110. User device 110 may perform these operations in response to processor 320 executing sequences of instructions contained in a computer-readable medium, such as memory 330. A computer-readable medium may be defined as a physical or logical memory device. The software instructions may be read into memory 330 from another computer-readable medium, such as data storage device 350, or from another device via communication interface 380. The software instructions contained in memory 330 may cause processor 320 to perform processes that will be described later. Alternatively, hard-wired circuitry may be used in place of or in combination with software instructions to implement processes consistent with the embodiments described herein. Thus, implementations described herein are not limited to any specific combination of hardware circuitry and software.

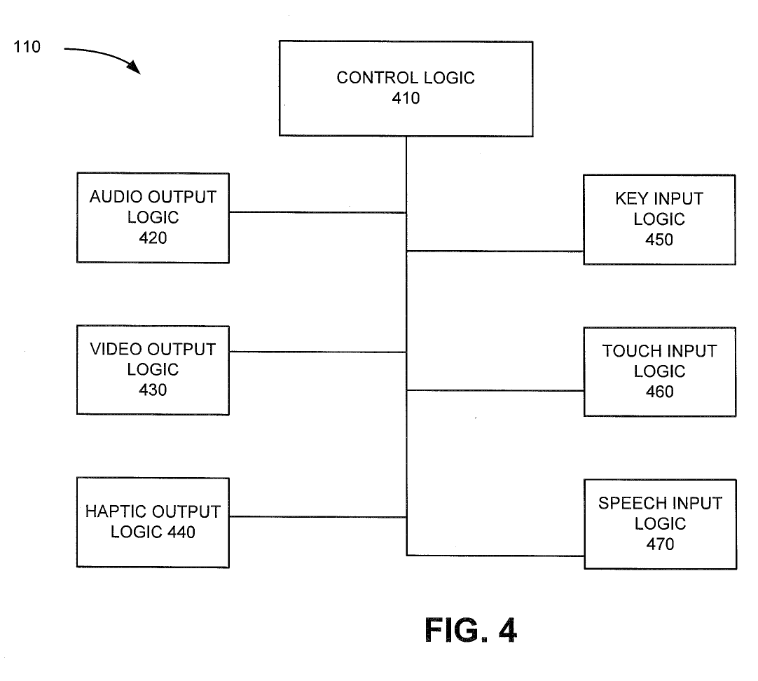

FIG. 4 is a functional block diagram of user device 110, according to an exemplary implementation. The logical blocks illustrated in FIG. 4 may be implemented in software, hardware, or a combination of hardware and software. For example, in one implementation, the logical blocks illustrated in FIG. 3 may be implemented by processor 320 (FIG. 3) executing software instructions stored in, for example, memory 330.

Referring to FIG. 4, user device 110 may include control logic 410, audio output logic 420, video output logic 430, haptic output logic 440, key input logic 450, touch input logic 460 and speech input logic 470. Control logic 410 may be used to control the machine/user interface of user device 110. For example, control logic 410 may determine an appropriate output to be provided via user device 110 and/or an appropriate type of input to be accepted by user device 110.

In an exemplary implementation, control logic 410 may cause user device 110 to provide one or more outputs in a group of N (e.g., three) potential outputs. For example, control logic 410 may cause user device 110 to provide one or more outputs when user device 110 receives an incoming call. In one implementation, the three potential outputs associated with the incoming call may include generating a ringtone, vibrating user device 110 and displaying a message, such as “incoming call” on display 230. Control logic 410 may provide one or more such outputs in the group based on any number of factors, such as presence or availability information associated with the user of user device 110, the mode in which user device 110 is operating, a physical location associated with user device 110, time of day, one or more applications being run by user device 10, a calendar of events identifying activities associated with the user of user device 110, a party or device communicating with user device 110, or any combination of these and/or other factors, as described in more detail below. By providing one or more outputs included in a group of potential outputs and based on particular factors associated with the user of user device 110, control logic 410 may reduce the cognitive load on the user and simplify use of user device 110.

Audio output logic 420 may control one or more speakers, such as speaker 220 (FIG. 2), to provide audio output, such as audio output identifying information associated with a message or call. For example, audio output logic 420 may provide a ringtone, music output, voiced output, text-to-speech output or any other audible output. Video output logic 430 may control a display, such as display 230, which may be an LCD display, a touch screen display, or some other type of display used to provide text, video or multimedia output for viewing by a user of user device 110. Haptic output logic 440 may include logic to control a vibrating mechanism or some other type of output mechanism that provides tactile feedback to a user of device 110 to indicate, for example, that an incoming call or message has been received.

Key input logic 450 may include logic to control a keypad, such as keypad 250, a keyboard, such as an alphanumeric keyboard, control buttons (e.g., control buttons 240), etc., that allows the user of user device 110 to enter text information, enter control commands, etc. Touch input logic 460 may include logic to control a touch screen of user device 110, such as display 230. Speech input logic 470 may include logic to control a speech-to-text converter that converts speech input provided by a user into text and/or commands associated with inputting information and/or controlling user device 110.

Control logic 410, as described in detail below, operates to control the user interface of user device 110 to provide a rich, multimedia user experience. In an exemplary implementation, control logic 410 may control various input/output mechanisms via logic 420-470 based on the various factors, as described in detail below.

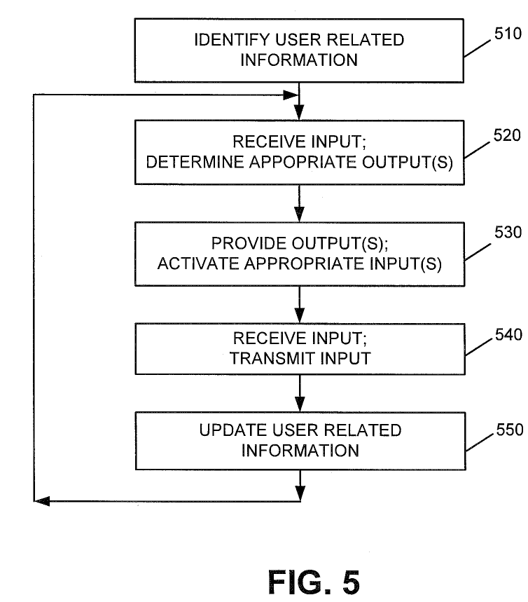

FIG. 5 is a flow diagram illustrating exemplary processing associated with managing the user interface of user device 110. In this example, assume that user device 110 is a communication device, such as a cellular phone, PDA, etc., capable of performing a multitude of tasks, such as making and receiving telephone calls, video sessions, emails, text messages and/or instant messages, such as mobile instant messages (MIMs), taking pictures and/or videos, surfing the Internet, downloading and executing applications/files, etc. In addition, assume that user device 110 is powered up.

Processing may begin with control logic 410 identifying various information or conditions associated with the user of user device 110 (act 510). For example, assume that user device 110 includes a calendar application program. In this case, control logic 410 may access the calendar application program and determine whether the user is currently in a meeting, at home, in his/her car, on travel, etc. For example, assume that the time is 9:20 AM and the user's calendar application program indicates that the user is in a meeting at his/her office from 9:00 AM to 10:00 AM. In this case, control logic 410 determines that the user is currently in a meeting.

Control logic 410 may also or alternatively determine an availability status of the user of user device 110 in other ways. For example, user device 110 may include a messaging program, such as an IM program, that allows the user to set an availability status indicator that provides information regarding the availability status of the user (e.g., available, busy, out of the office, in a meeting, etc.). In other implementations, control logic 410 may determine a physical location associated with the user via GPS, wireless signal triangulation, or some other mechanism. In each situation, control logic 410 may use the availability information and/or other information associated with the user of user device 110 to tailor the user interface.

For example, assume that user device 110 receives a communication input, such as a text message, from user device 120 (act 520). Control logic 410 may identify appropriate output mechanism(s) to alert the user of the received message (act 520). For example, user device 110 may be able to provide an audio alert (e.g., a beep) via speaker 220 (FIG. 2), a visual alert (e.g., a video “pop-up”) via display 230 and/or a haptic output, such as a vibration, via a vibrator output mechanism of user device 110.

In this example, assume that control logic 410 has determined that user is in a meeting at work. In this case, control logic 410 may determine that video output logic 430 and/or haptic output logic 440 should be activated to alert the user of the incoming message. Control logic 410, however, may determine that audio output logic 420 should not be activated to notify the user of the incoming call, in order to not disturb or disrupt the meeting with an unwanted beeping or ringing.

As another example, assume that the user is in his/her car when the message from user device 120 is received. In this case, control logic 410 may determine that audio output logic 420 should be activated to alert the user of the incoming call and that video output logic 430 and haptic output logic 440 should not be activated to alert the user of the incoming call. That is, the user will be alerted with a beeping or some other audible output via speaker 220 as to the incoming call. This will avoid the user having to take his/her eyes off the road to view display 230 to determine that a call has been received or avoid the user having to keep user device 110 in his/her pocket in order to feel a vibration.

In each case, control logic 410 may activate the appropriate output logic. The activated output logic (e.g., one or more of audio, video and haptic output logic 420-440) may then output the indication of the incoming communication to the user (act 530).

Control logic 410 may also determine appropriate input mechanism(s) to activate based on the status/availability information (act 530). For example, if the user of user device 110 is in a meeting at work, control logic 410 may activate key input logic 450 and/or touch input logic 460 to allow the user to enter a response via, for example, keypad 250 of user device 110 or touch screen display 230. Control logic 410, however, may not activate or may deactivate speech input logic 470 since the user would not typically want to disrupt the meeting by carrying on a conversation with another party. In addition, speech input logic 470 may be adversely impacted by other people in the meeting who may be talking (e.g., be unable to perform accurate speech recognition). Therefore, speech input logic 470 may not be activated in this scenario.

The user of user device 110 may then provide input via, for example, keypad 250 (act 540). As an example, the user may read the text message and key in a response via keypad 250. The user may then transmit the response to user device 120 (act 540).

The user may continue to interact with the other party at user device 120 via text messages. For each incoming message, control logic 410 may control output logic 420-440 and input logic 450-470 to provide the user with the richest interactive interface possible, based on the particular circumstances. In addition, by limiting or restricting the types of input and output mechanisms used to communicate based on user availability or other information, control logic 410 may reduce the cognitive load on the user with respect to interacting with user device 110. That is, by reducing available input/output mechanisms for a particular scenario, the user will be presented with a simpler, more intuitive user interface.

As another example, assume that the user is at home in the evening. In this case, control logic 410 may provide all three of audio, video and haptic outputs and enable all three of key, touch and speech input mechanisms. For example, control logic 410 may access the user's, calendar and/or determine an availability status. Since the user is at home, assume that the availability status is “available” or “at home.” Further assume that the user's calendar stored in user device 110 indicates that the user has no scheduled activities. In this case, audio, video and haptic output logic 420-440 may activate audio, video and haptic output channels/mechanisms to alert the user of, for example, incoming communications. In addition, all three of key input, touch input and speech input logic 450-470 may active key, touch and speech input channels/mechanisms to allow the user to respond to a received communication using any three of these input channels/mechanisms. In each case, control logic 410 may identify one or more appropriate output mechanisms and input mechanisms based on particular circumstances. This may provide a rich multi-media user experience, and also allow the user to more easily interact with user device 110 and reduce the cognitive load of the user associated with interacting with various functionality/programs executed by user device 110.

User device 110 may also update the user-related information (e.g., availability status) on a real-time or near real-time basis (act 550). For example, control logic 410 may update the user information at periodic intervals (e.g., every second, 10 seconds, 30 seconds, 5 minutes, etc.). Alternatively, control logic 410 may continuously monitor various applications/status indicators and immediately determine when the status of the user has changed (e.g., an IM availability status changes from available to unavailable). This enables control logic 410 to provide an appropriate input/output mechanism to the user as circumstances change, while still providing the richest user experience based on the particular situation.

As described above, in some implementations, control logic 410 may identify various operating conditions and tailor various input and output channels to provide the user with an intelligent, user-friendly interface. In some implementations, control logic 410 may use a processing or decision tree structure for providing particular input/output mechanisms to utilize.

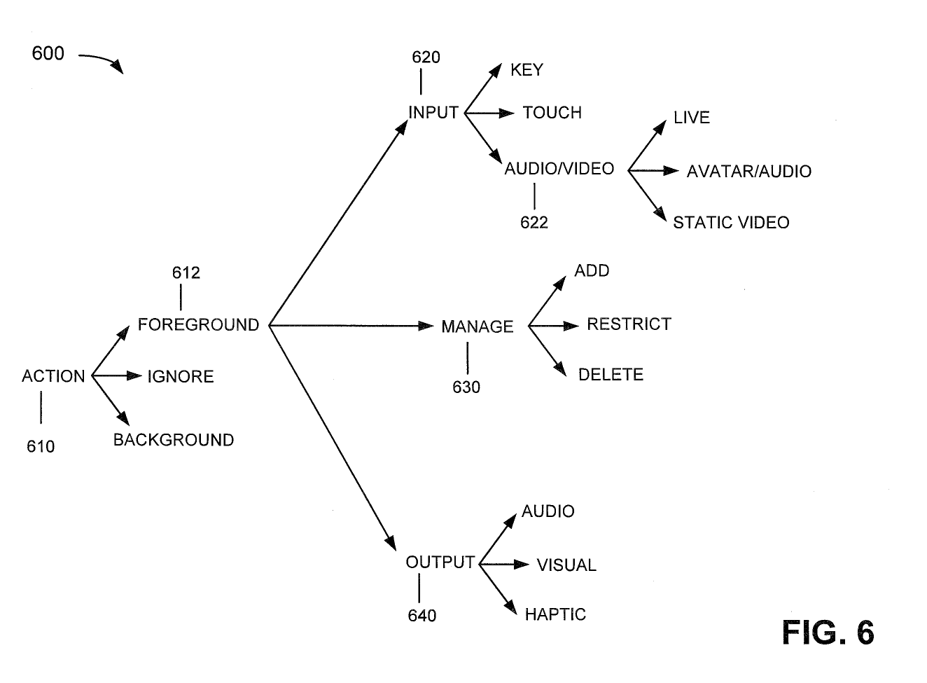

For example, FIG. 6 illustrates an exemplary processing/decision tree that may be used by control logic 410. Referring to FIG. 6, processing tree 600 includes an initial action 610. Action 610 may represent an action or input received by or provided to user device 110, such as an incoming message. Action 610 may also represent a timed alert to be provided to the user (e.g., a reminder), or any event that may require a response. As illustrated in FIG. 6, processing tree 600 may include three branches: 1) foreground (labeled point 612), 2) ignore, and 3) background. Foreground 612 may correspond to control logic 410 handling or processing the action immediately. Ignore may correspond to a situation in which no further action is required and control logic 410 may ignore the action. For example, the user may set a preference for a particular caller indicating that incoming communications from that particular caller are to be ignored (e.g., user device 110 is not to activate any audio, video or haptic output mechanisms when the communication is received) and is to merely store an indication that the particular caller has sent a communication. Background may correspond to control logic 410 deferring handling of the action to a later time.

As an example, assume that action 610 corresponds to receiving a text message, such as an IM. Further assume that control logic 410 has determined that the user is available and that the message should be handled or processed immediately (i.e., foreground 612).

As further shown in FIG. 6, foreground point 612 includes three options for control logic 410: 1) input option 620; 2) manage option 630; or 3) output option 640. Input option 620 may involve control logic 410 activating one or more of key input mechanisms via, for example, key input logic 450, touch input mechanisms via, for example, touch input logic 460 or audio/video inputs via, for example, speech input logic 470. The user of user device 410 may then provide input to user device 110 based on the particular circumstances, as described above with respect to FIGS. 4 and 5.

Referring back to FIG. 6, processing tree 600 may also provide a number of branches/options with respect to audio/video input, labeled point 622. For example, processing tree 600 may include branches for live, avatar/audio and static video. The “live” branch may correspond to control logic 410 providing or activating a live streaming input mechanism, such as activating a camera device included on user device 110 that may then be used to provide live streaming video to another device. The avatar/audio branch may correspond to control logic 410 activating an avatar/audio input mechanism on user device 110. This option may allow the user to use an avatar to provide audio/video output or provide output without using an avatar. The static video branch may correspond to control logic 410 activating video input mechanisms on user device 110 that allow a user to respond via various video inputs, including pre-stored video clips or streaming of a single image (or multiple images), such as a photograph of the user. In each case, control logic 410 may automatically select the appropriate input mechanism, based on a number of factors (e.g., availability status, time of day, location, etc.) as described above with respect to FIG. 5.

At point 612, processing tree 600 may also include a manage option 630. For the manage option 630, control logic 410 may allow the user to, for example, add a party to a messaging/chat session, restrict a party from a messaging session and delete a third party from an ongoing messaging session between user device 110 and user device 120. Control logic 410 may facilitate such management options using various icons or pictures representing parties, such as the parties at user devices 120 and 130, via easy to use inputs, such as various single keystrokes on a keypad or keyboard to perform various functions, via voice inputs, etc., as described in more detail below.

At point 612, processing tree 600 may include an output option 640. For the output option 640, control logic 410 may control or activate one or more audio, visual or haptic output mechanisms, such as logic 420-440, in a similar manner to that described above with respect to FIG. 5.

In each case, control logic 410 may traverse tree structure 600 tree to provide various input/output mechanisms, allow the user interact with other parties, perform various functions, etc., and provide the user with a media rich, user-friendly interface. Again, the particular input/output mechanisms may be based on user-related information. However, in each case, control logic 410 activates/provides the appropriate input/output mechanisms, such as providing one or more of N outputs and activating one or more of M inputs, to help reduce the cognitive load on the user with respect to performing the desired function.

Implementations described above have focused on providing audio, visual and/or haptic output and activating various key, touch or speech input mechanisms via the user interface of user device 110. It should be understood that control logic 410 may control various input/output mechanisms to provide different types of input/output in any number of ways. For example, control logic 410 may provide any number of N and M inputs and outputs, including any number of audio, visual and/or haptic input/outputs based on the particular circumstances.

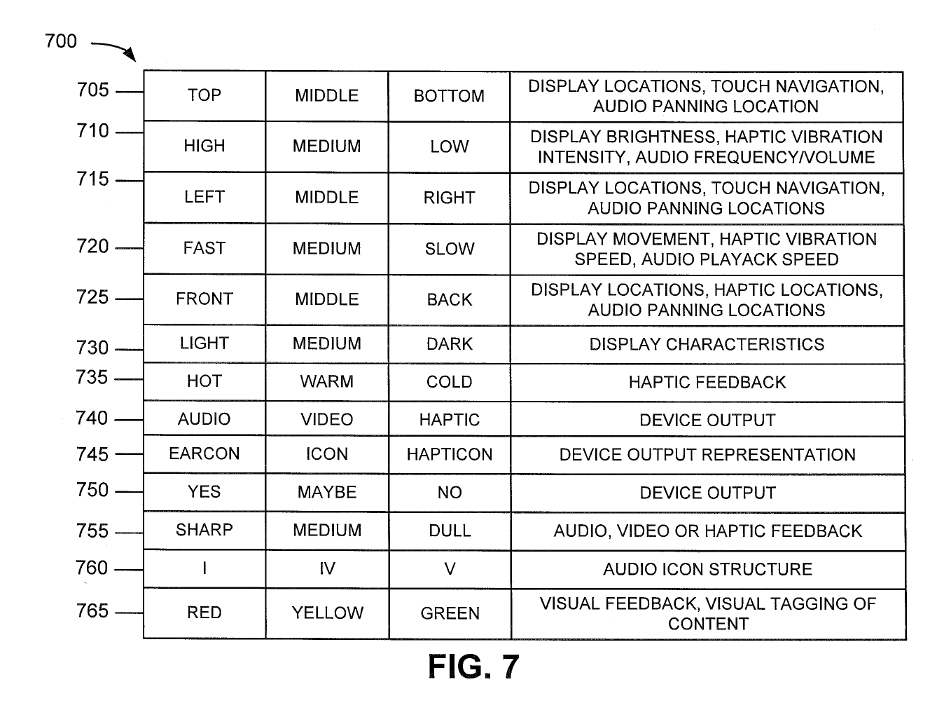

For example, FIG. 7 provides an exemplary table 700 of various inputs/outputs provided via user device 110. Control logic 410 may provide inputs/outputs in accordance with any of the entries in table 700. For example, entry 705 includes top, middle, bottom, which may correspond to control logic 410 outputting information at three different display locations on, for example, display 230, to provide touch screen navigation/functionality at different locations or to provide audio panning locations at different locations of user device 110. Entry 710 includes high, medium or low, which may correspond to control logic 410 controlling display brightness, haptic vibration intensity and audio frequency/volume using one of these three different levels. Entry 715 includes left, middle and right, which may correspond to control logic 410 controlling display locations, touch navigation or audio panning locations at three different areas of user device 110. Entry 720 includes fast, medium or slow, which may correspond to control logic 410 controlling display movement, haptic vibration speed or audio playback speed at one of these three different rates.

As an example corresponding to entry 720, assume that user device 110 receives a telephone call from a party designated in an address book/contact list as an important party (e.g., spouse, child, boss, etc.). Further assume that the user of user device 110 is in a meeting at work when the important party calls user device 110. In this case, haptic output logic 440 may pulse or vibrate a vibrating mechanism with a particular frequency or intensity that corresponds to an important caller. In this manner, the user may sense the particular vibration-related output and determine that he/she has received an important communication. This may be useful in situations where the user's hands are occupied (e.g., driving) and the user is unable to quickly access user device 110.

As another example, haptic output logic 440 may provide vibrations that are associated with a particular ringtone of a calling party. For example, if user device 110 has set up different ringtones for different callers, in situations where using audio output is not appropriate (e.g., user is in a meeting), haptic output logic 440 may control a vibrating mechanism to vibrate or pulse in time or to the beat of the song/ringtone associated with each particular caller. The user may be able to determine the caller by sensing the different vibration patterns.

Referring back to FIG. 7, entry 725 may include front, middle and back, which may correspond to control logic 410 controlling display locations, haptic locations and audio panning locations via a front, middle or back locations of display 230 or user device 110. Entry 730 may include light, medium or dark, which may correspond to control logic 410 controlling display characteristics via light, medium or dark colors or intensities. Entry 735 may include hot, warm and cold, which may correspond to control logic 410 controlling haptic feedback mechanisms to provide hot, warm or cold tactile feedback/sensations. Entry 740 may include audio, video or haptic, which may correspond to control logic 410 providing various device outputs as described above with respect to FIG. 4. Entry 745 may include earcon, icon and hapticon, which may correspond to control logic 410 controlling various device output representations, such as output representations associated with hearing, seeing or feeling device outputs. Entry 750 may include yes, maybe and no, which may correspond to control logic 410 optionally providing output based on the particular circumstances, such as user availability. Entry 755 may include sharp, medium and dull, which may correspond to control logic 410 controlling audio, video or haptic feedback via sharp, medium or dull sounds/pictures/tactile sensations. Entry 760 may include I, IV and V, which may correspond to control logic 410 providing an audio icon or audio output sequence utilizing tones or progressions of a musical chord or key, such as the first, fourth and fifth notes of a particular chord or key that control logic 410 may provide via an audio output channel. The particular note that is output may provide the user with information identifying the particular output. Entry 765 may include red, yellow and green, which may correspond to control logic 410 providing visual feedback and visual tagging of content using red, yellow or green colors.

Table 700 provides exemplary variations associated with input/output mechanisms on user device 110 and corresponding ways in which control logic 410 and/or other devices of user device 110 may provide or modify these input/output mechanisms/channels to provide a rich, multimedia interface. It should be understood that additional or different groups of input/outputs may be provided via user device 110 in other implementations. In addition, in some implementations, the particular input/output mechanisms of user device 110 may be preconfigured prior to purchase of user device 110. However, in some implementations, the user may modify or change any of the configurations associated with the user interface of user device 110 to provide his/her own customized input/output mechanisms based upon the particular circumstances.

In some implementations, the user's experience with respect to performing various functions via user device 110 may be further enhanced using a messaging manager. For example, user devices, such as cell phones, PDAs, etc., play an increasingly valuable part in allowing users to stay in communication with one another. In an exemplary implementation, a messaging manager may manage various different or heterogeneous messaging applications to facilitate and manage communication sessions, including multi-party sessions and multi-media communication sessions.

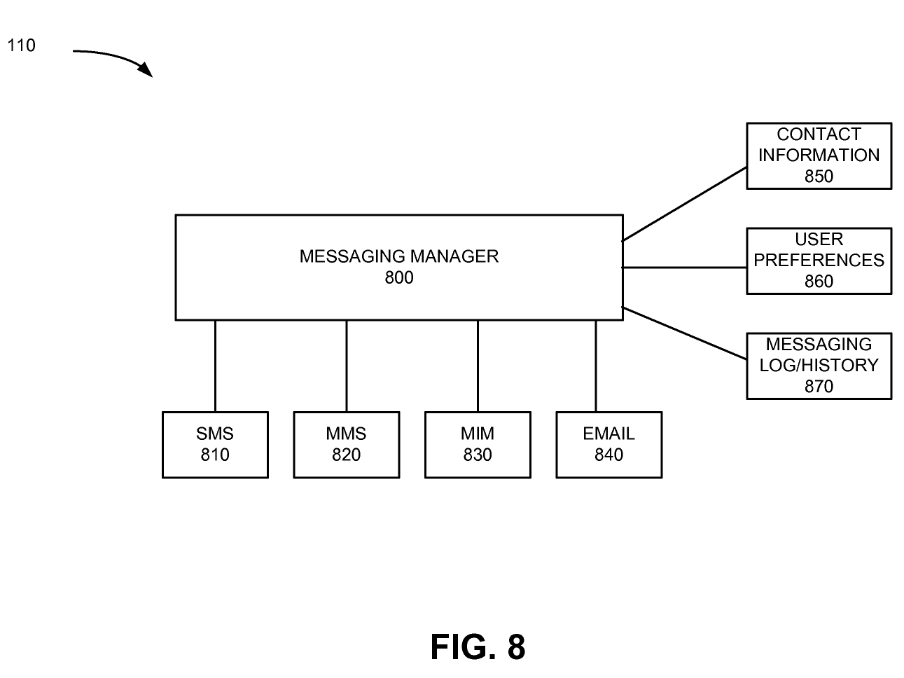

FIG. 8 is a functional diagram illustrating components implemented in user device 110 according to an exemplary implementation. Referring to FIG. 8, user device 110 may include messaging manager 800, short message service (SMS) program 810, multimedia messaging service (MMS) program 820, mobile instant messaging (MIM) program 830 and email program 840. Messaging manager 800 may be implemented in control logic 410, by processor 320 executing instructions stored in memory, such as memory 330, or by other components in user device 110. Messaging manager 800 may manage messaging programs and/or aid various messaging programs, such as one or more of programs 810-840, to provide, for example, multi-party messaging sessions, as described in detail below.

SMS program 810, MMS program 820, MIM program 830 and email program 840 may allow the user of user device 110 to communicate via SMS messages, MMS messages, mobile IM, and email, respectively. These programs may be stored on user device 110, such as in memory 330 or storage device 350 (FIG. 3).

As further shown in FIG. 8, user device 110 may also store contact information 850, user preferences 860 and messaging log/ history 870 in memory, such as memory 330, storage device 350 or another memory on user device 110. Contact information 850 may include an address book storing information, such as telephone numbers, email addresses, and/or IM user names/identifiers, associated with friends, family, etc., of the user of user device 110. Contact information 850 may also include information associated with a calendar application executed by user device 110, such as schedule information, meeting information, travel information, etc., of the user of user device 110. Contact information 850 may further include a “buddy list” identifying information various parties with whom the user of user device 110 may communicate. The “buddy list” may include IM usernames, identifiers, icons/pictures associated with the users in the list, etc., for parties who frequently communicate with the user of user device 110 via, for example, text messages, including IMs.

User preferences 860 may store preference information associated with the configuration of user device 110. For example, user preferences 860 may store preference information indicating types of input mechanisms via which the user would like to receive indications of incoming messages, display setting for displaying various message, handling instructions for handling certain types of message, such as email messages, etc.

Messaging log/history 870 may store a log of communications to/from user device 110. This information may be stored for a predetermined period of time and automatically erased after the period of time has expired. Alternatively, the user may set a user preference in user preferences 860 indicating a particular period of time for which user device 110 is to keep messages or for which messages are stored in network 140. For example, the user may decide that he/she would like to keep messages from family members for a longer period of time than messages from work associates. In this case, the user may set different periods of time for saving messages from different messaging partners.

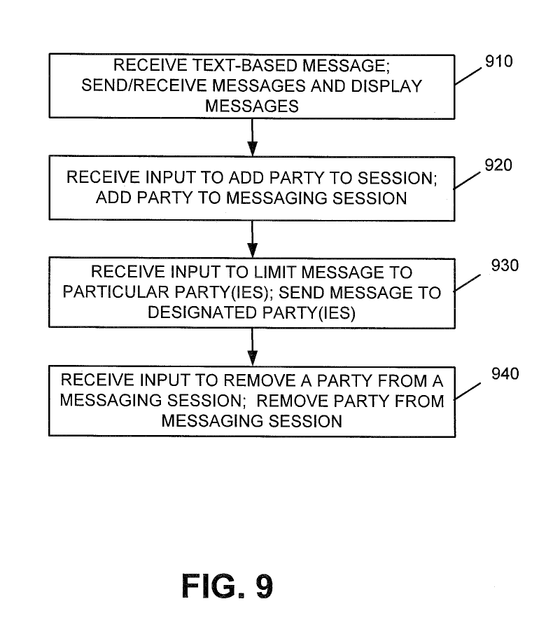

Messaging manager 800, as described above, may facilitate communication sessions, including multi-party sessions for a user of user device 110. FIG. 9 illustrates exemplary processing associated with a communication session. Processing may begin with user device 110 receiving a text-based message sent from user device 120 (act 910). User device 110 may process the message using the appropriate messaging application (e.g., one of applications 810-840). For example, assume that the message is a MIM received from a user named Bob at user device 120. Further assume that the user at communication device 110, Paul, is provided with an indication of the initial message, and optionally subsequent messages, via one or more of audio, visual or haptic output mechanism as described above with respect to FIGS. 4 and 5. MIM program 830 and/or messaging manager 800 interacting with MIM program 830 may display the received message.

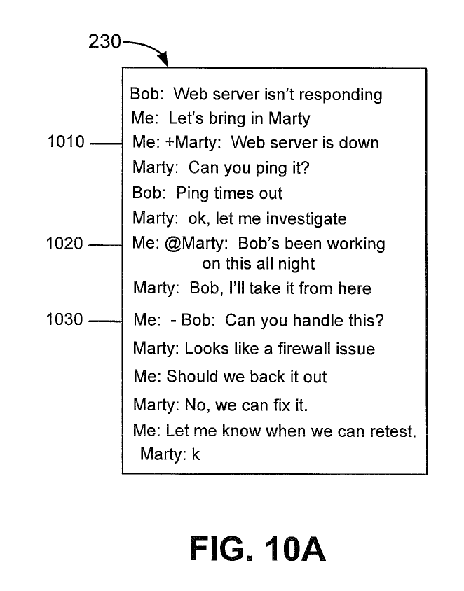

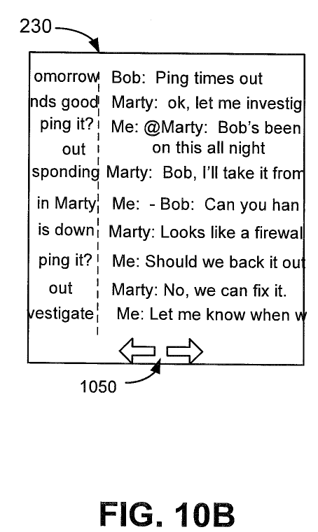

MIM program 830 and/or messaging manager 800 may then facilitate a messaging session between Paul and Bob by transmitting messages generated by Paul from user device 110 and receiving messages sent by Bob from user device 120 (act 910). User device 110 may also display the transmitted and received messages (act 910). For example, FIG. 10A illustrates a portion of an exemplary messaging/chat session provided on display 230. In this example, the messaging session between Bob and Paul (indicated as “Me” on display 230) involves a web server problem that Bob is working on.

Now assume that Paul would like to add another party to the messaging session, such as Marty at user device 130. In an exemplary implementation, messaging manager 800 may provide a number of input mechanisms to easily allow Paul to add a party to the messaging session. For example, Paul may enter the plus sign (+) via keypad 250 (FIG. 2), followed by inputting “Marty,” to add Marty to the messaging session (act 920). For example, FIG. 10A illustrates that message 1010 begins with +Marty, followed by a text message to Marty. Messaging manager 800 may receive the input to add Marty (i.e., +Marty). Messaging manager 800 may then automatically identify communication information (e.g., header information, such as an IP address, username, location, etc.) corresponding to Marty from, for example, Paul's buddy list stored in contact information 850 or elsewhere on user device 110. Messaging manager 800 and/or MIM program 830 may send the message (i.e., “Web server is down” in this example) to user device 130, which corresponds to Marty's user device, so that Marty can be included in the messaging session. Messaging manager 800 may also send the message (i.e., “Web server is down” in this example) to user device 120 (i.e., Bob's user device). Paul, Marty and Bob may then begin communicating via a multi-party messaging session.

For example, Marty may query Bob and Paul regarding the problem and all three parties will be able to view messages and respond in a multi-party session, as illustrated in display 230 of FIG. 10A. In this case, assume that Paul would like to restrict one or more of the messaging parties from receiving a message. In an exemplary implementation, Paul may input the “at” sign (i.e., @) to limit the transmission of the message to only the desired party or parties, thereby restricting a particular message from another party or parties (act 930). For example, as illustrated at message 1020 in FIG. 10A, Paul may type in “@Marty” followed by a message. In this case, messaging manager 800 may send the message input after “@Marty” (i.e., Bob's been working on this all night in this example) to Marty only (act 1030). This may be useful in situations where the sender does not want everyone (i.e., Bob in this case) to view the message.

Further assume that Paul at user device 110 would like to remove a party from the messaging session. In an exemplary implementation, Paul may input the “minus” sign (i.e., −) followed by the party that he wishes to remove (act 940). For example, as illustrated at message 1030, Paul may type in “−Bob”, followed by a message. Messaging manager 800 may then remove or delete Bob from the session and send the message to Marty (act 940). Paul and Marty may then continue to communicate via the messaging session, with Bob being closed out of the ongoing session. Bob, however, can be re-joined in the session at a later time by Paul (or Marty) entering +Bob.

In some implementations, a third party may wish to join a session between a user of user device 110 and a second party. In this case, messaging manager 800 may receive the request and provide a message on display 230 or an audio output via speaker 220 (FIG. 2) indicating that a third party would like to join the communication session. The user may then select “add” on display 230 or voice “add” to allow the third party to enter the communication session. Similar to the discussion above with respect to FIGS. 4 and 5, the particular output mechanism used to alert the user of the request of the third party may be based on the particular circumstances (e.g., availability status, location, party making the request, etc.).

The processing described above with respect to FIG. 9 uses simplified keypad or keyboard inputs, such as a one key mechanism (e.g., a single keypad or keystroke input such as the plus sign, the at sign, the minus sign), to quickly enter command information that will be used to control a multi-party messaging session. It should be understood that alternative keypad or keyboard inputs may be used to perform these and other functions. In addition, in alternative implementations, the user at user device 110 may also use icons or pictures associated with various parties to add parties, delete parties, restrict parties from receiving one or more messages, etc. For example, a user may select or click on an icon or picture associated with a particular party to add that party to a messaging session. In still other implementations, speech input may be used to provide commands to a messaging program.

For example, in an alternative implementation, Paul at user device 110 may voice “add Marty” or similar language in order to add Marty to the messaging session. In this case, speech input logic 470 (FIG. 4) may use speech recognition logic to identify that the user would like to add Marty to the messaging session. Similarly, to restrict a message to only Marty, the user may voice “only Marty,” and to remove a party, the user may voice “remove Bob”. In this implementation, user device 110 may use speech recognition to convert voiced input into the desired command.

In addition, in some implementations, haptic feedback may be provided in conjunction with other feedback mechanisms to aid in managing messaging sessions. For example, haptic output logic 440 may be used to provide tactile feedback to the user for each of the various actions. As one example, after Paul inputs @Marty to restrict Bob from a particular message, haptic output logic 440 may provide a particular vibration or other tactile output (e.g., a hapticon) to inform the user that Bob was restricted from the message. The particular tactile feedback or hapticon may be provided based on the particular action performed by Paul. In addition, specific actions that trigger tactile feedback, as well as the particular tactile feedback provided, may be set by the user and stored in user preferences 860.

Messaging manager 800 may also facilitate messaging sessions, including multi-party messaging sessions in other ways. For example, messaging manager 800 may use different techniques to display messages associated with a messaging session. As one example, display 230 may provide messages from a messaging session in a “page” mode, as illustrated in FIG. 10B. Referring to FIG. 10B, display 230 includes earlier messages located on the left side of the dotted line and more recent messages located on the right side of the dotted line. In some implementations, instead of a dotted line or other line separating the messages, display 230 may provide messages using a display format that more closely resembles pages in a book. That is, the left side of display may resemble one page and the right side may resemble the subsequent page of the book. In each case, the user may use one of control keys 240, a scroll bar/button or forward/reverse arrows, such as arrows 1050 shown on display 230 in FIG. 10B, or voice input to scroll backward and forward to read earlier or more recent messages. In this manner, the user at user device 110 may read a log of messages in a manner similar to reading pages of a book and/or may “flip” between pages to quickly go back to earlier/later portions of the conversation. In alternative implementations, vertical scrolling may be used, as opposed to horizontal scrolling, to scroll between earlier and more recent messages. In still other implementations, different pages could be displayed by fading a page associated with earlier communications to the background and moving a more recent page toward the front of the display. In addition, different “pages” of the session may be displayed using different color backgrounds or via other display techniques. The log of messages may also be stored in messaging log/history 870.

In some implementations, a user who has recently been added to a communication session that has been ongoing for a period of time may be able to view a messaging history from user device 110. For example, in FIG. 10A, when Marty was added to the communication session at message 1010, messaging program 800 may send Marty an earlier portion of the communication session between Bob and Paul. This may allow Marty to scroll back to earlier messages and quickly come up to speed with respect to the communication session.

In addition, messaging manager 800 may allow the user to handle multiple communications concurrently. For example, Paul may communicate with Bob and Marty during a first session as described above, and also communicate with Jane and Bill during a second communication session that overlaps in time the first session with Bob and Marty. In this case, messaging manager 800 may flip between sessions to allow Paul to easily communicate with parties in both sessions. For example, messaging manager 800 may display messages in page-like mode in which messages from a first session are displayed on a current page and messages from another session are displayed on a different page. Alternatively, messaging manager 800 may fade a session in which Paul is not currently communicating to a background of display 230 or show the two sessions in a windowed manner. When user device 110 receives a communication involving the second session (and if Paul is not currently composing a message for the first session), the second communication session may be displayed as the current page, or brought to the foreground of display 230, and the first session moved to the background. In either case, messaging manager 800 may allow the user to easily flip or change between two or more concurrent messaging sessions.

In other instances, messaging manager 800 may use colors to enhance the user's experience with respect to messaging sessions. For example, different colors of text may be used to identify different messaging parties. As an example, messages from Marty may be displayed in red, messages from Bob may be displayed in blue and messages from Paul may be displayed in black on display 230. This may make it easier for the user to quickly determine who is texting/messaging. Messaging manager 800 may also use different color backgrounds for different communication sessions to enable the user to more easily track the various communication sessions. In still other implementations, different icons, avatars, pictures, emoticons, etc., associated with the different messaging partners may be used to enable the user to quickly identify various messaging parties.

In some implementations, messaging manager 800 may abstract unnecessary messaging details from the user and allow the user to interact with messaging manager 800 without having to consider whether to reply to a received message via a particular messaging program. For example, in some implementations, the user at user device 110 can simply interact with messaging manager 800 without worrying about whether to reply to a received message via email, MIM program 830, etc.

As an example, user device 110 may receive a message from another device and messaging manager 800 may display the received message on display 230. The user may then simply enter text to respond to the displayed message and messaging manager 800 may send the reply via the appropriate messaging program (i.e., SMS program 810, MMS program 820, MIM program 830, email program 840). In such instances, messaging manager 800 may automatically select the appropriate program and/or protocol for responding to a received message.

In still other implementations, the user of user device 110 may set preferences with respect to responding to various messages. For example, in some implementations, email messages may be analyzed to determine a proper “fit” for being provisioned via messaging manager 800. As an example, in some instances, relatively short, person-to-person or one-to-few emails may be considered a good fit for processing via messaging manager 800. However, lengthy or verbose emails, many-to-many emails (i.e., many “To” recipients and/or many “CC” recipients) and messages with multiple attachments may be considered to not be good fits for provisioning via messaging manager 800.

In such instances, messaging manager 800 may access the user's preferences regarding how he/she would like to handle “bad fit” email messages. For example, user preferences 860 may indicate that messaging manager 800 may not respond to email messages that include more than three receiving parties. In such as case, the user may use email program 840 to compose and send replies, with no additional interaction with messaging manager 800.

Alternatively, messaging manager 800 may prompt the user with respect to how he/she would like to handle email messages that are identified as being bad fits/inappropriate for handling via messaging manager 800. For example, messaging manager 800 may provide a visual prompt on display 230 to inquire as to whether messaging manager 800 should forward the message to the appropriate parties. In either case, (i.e., preset preference or the user selects how he/she would like to respond), messaging manager 800 may operate in conjunction with the particular messaging program to allow the user to respond using the desired application (e.g., via email program 840 or via messaging manager 800).

In instances where messaging manager 800 may be used to respond to the email message, messaging manager 800 may abstract or extract messaging protocol details associated with the received message and allow the user to respond to the message in the desired manner. Messaging manager 800 may also abstract or extract messaging protocol information and/or details associated with user devices that may be executing a different version of a messaging program than that executed by user device 110. In such instances, messaging manager 800 may automatically make any necessary modifications “on the fly” to allow the user to communicate with such other devices.

Implementations described herein illustrate a user interface that controls audio, video and/or haptic input/output mechanisms. In addition, implementations described herein provide for managing communication sessions, including multi-party, multi-media messaging sessions.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

For example, various features have been mainly described above with respect to a managing a user interface of a mobile device and/or managing messaging sessions between mobile devices. In other implementations, features described herein may be implemented in other types of media devices, such as a PC, laptop computer, television, gaming system, remote control etc., to simplify the user interface and reduce the cognitive load on the user. In still other implementations, messaging sessions described above as being between mobile devices may involve different types of devices, such as mobile devices, PCs, televisions, gaming systems, etc. That is, a mobile device may communicate with a PC, a television, a gaming system or other device during a multi-party messaging session. Still further, messaging manager 800 may allow a user to transfer a messaging session from a mobile device to another device. For example, when a user comes home, the user may wish to transfer a messaging session from his/her cell phone to a PC or television. In this case, messaging manager 800 may include an icon or a selection button to allow the user to easily transfer a current communication session to another device. The user may then continue to communicate via the other device.

Further, while series of acts have been described with respect to FIGS. 5 and 9, the order of the acts may be varied in other implementations. Moreover, non-dependent acts may be implemented in parallel.

It will also be apparent that various features described above may be implemented in many different forms of software, firmware, and hardware in the implementations illustrated in the figures. The actual software code or specialized control hardware used to implement the various features is not limiting. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

What is claimed is:

1. A device, comprising:
a communication interface configured to receive communications from other devices;
a user interface configured to provide at least one of audio, video or haptic output in response to received communications, the user interface including groups of potential outputs; and
logic configured to:
identify information associated with an availability status of a user of the device,
receive a first communication from an other device, and
provide one or more outputs in one of the groups of potential outputs via the user interface based on the information associated with the availability status of the user of the device.

2. The device of claim 1, wherein when identifying information associated with the availability status of the user, the logic is configured to:
determine the availability status based on at least one of information stored in a calendar application, availability information associated with a messaging program, availability information input by the user, a location of the device, a current time, or a party associated with the first communication.

3. The device of claim 1, wherein the logic is further configured to:
provide at two of audio, video or haptic output in the one group based on the information associated with the availability status of the user,
activate at least two of a keypad input mechanism, a speech recognition mechanism or a touch screen input mechanism based on the information associated with the availability status of the user,
detect a change in the availability status of the user, and
change at least one of the audio, video or haptic output to be provided to the user based on the detected change.

4. The device of claim 1, wherein the logic is further configured to:
identify a first party associated with the first communication, and
provide an alert via the user interface based on the identified first party.

5. The device of claim 4, wherein when providing an alert, the logic is configured to:
providing a first haptic output based on a ringtone associated with the first party or based on a priority status associated with the first party.

6. The device of claim 1, wherein the logic is further configured to:
identify the one group based on the availability status of the user, the one group corresponding to a limited portion of potential outputs available via the user device, and
control the user interface to accept a limited portion of a plurality of potential inputs available via the user device based on the availability status of the user.

7. A device, comprising:
a communication interface configured to receive communications from a first party and transmit communications from a user of the device to the first party;
a display configured to display the communications received from the first party and the communications transmitted from the user, the communications between the user and the first party corresponding to a messaging session;
an input device; and
logic configured to:
receive input from the user via the input device to add a second party to the messaging session, the input comprising one of a single keyboard input, a single keypad input, an icon selection or audio input from the user of the device, and
add the second party to the messaging session based on the received input.

8. The device of claim 7, wherein the input comprises a keyboard or keypad input corresponding to a plus sign.

9. The device of claim 7, wherein the input comprises:
a voice command from the user of the device.

10. The device of claim 7, wherein the logic is further configured to:
output, via the display, communications from the first party in a first color and communications from the second party in a second color, the first and second colors being different.

11. The device of claim 7, wherein the input device is further configured to:
receive input from the user to limit the transmission of a communication to only a designated one of the first party or second party, the input comprising a voice command or a keypad or keyboard input, and wherein the logic is further configured to:
forward the communication for transmission via the communication interface to the designated one of the first party or second party.

12. The device of claim 7, further comprising:
a memory configured to store a plurality of communications between the user and the first and second parties, wherein the logic is further configured to:
display the plurality of communications in a page-like format, wherein the user may scroll backward or forward using the input device to view earlier or more recent communications.

13. The device of claim 12, wherein the logic is further configured to:
forward at least some of the plurality of communications stored in the memory to the second party, the at least some of the plurality of communications corresponding to communications of the messaging session that were made prior to the second party joining the messaging session.

14. The device of claim 7, wherein the logic is further configured to:
receive electronic mail messages via the communication interface,
access information associated with processing received electronic mail messages, and
process responses, provided by the user, to the electronic mail messages based on the accessed information.

15. The device of claim 14, wherein the logic is further configured to:
transmit some responses to the received electronic mail messages via an electronic mail program, and
transmit other responses to the received electronic mail messages via a messaging manager application.

16. A method, comprising:
receiving, by a mobile device, a communication from a first party;
transmitting, by the mobile device, a response from a user of the mobile device to the first party;
displaying a plurality of messages, received by the mobile device from the first party and transmitted by the mobile device to the first party, the plurality of messages corresponding to a communication session between the user of the mobile device and the first party;
receiving input from the user to add a second party to the communication session between the user and the first party, the input comprising a voice command, keypad input or keyboard input; and
adding the second party to the communication session.

17. The method of claim 16, further comprising:
displaying, by the user device, messages from the user in a first color, messages from the first party in a second color, and messages from the second party in a third color, the first, second and third colors being different from one another.

18. The method of claim 16, further comprising:
receiving input from the user to remove the first party from the communication session, the input comprising a voice command or keypad or keyboard input.

19. The method of claim 16, further comprising:
storing a plurality of messages between the user and the first party; and
forwarding at least some of the plurality of messages to the second party, the at least some of the plurality of messages corresponding to messages transmitted between the user and the first party prior to the second party joining the communication session.

20. The method of claim 16, further comprising:
receiving electronic mail messages;
transmitting some responses to received electronic mail messages via an electronic mail application; and
transmitting other responses to received electronic mail messages via a messaging program.

21. A computer-readable medium having stored thereon sequences of instructions which, when executed by at least one processor, cause the at least one processor to:
identify information associated with an availability status of a user of a device;
receive a first communication from an other device; and
provide an audio, video or haptic output via a user interface of the device based on the information associated with the availability status of the user of the device.

22. The computer-readable medium of claim 21, further including instructions for causing the at least one processor to:
manage a messaging session between a user of the device and a first party associated with the other device;
output messages from the messaging session in a page-like format; and
allow the user of the device to scroll or page to earlier portions of the messaging session.

23. The computer-readable medium of claim 22, further including instructions for causing the at least one processor to:
receive input from the user of the device to add a second party to the messaging session and restrict a message for transmission to only a designated one of the first party or second party, the input comprising at least one of selection of an icon or use of one or more symbols on a keypad or keyboard.
